(19) United States
(12) Patent Application Publication
(10) Pub. No.: US 2012/0121935 A1
(43) Pub. Date: May 17, 2012

(54) PROBE, METHOD FOR MANUFACTURING PROBE, PROBE MICROSCOPE, MAGNETIC HEAD, METHOD FOR MANUFACTURING MAGNETIC HEAD, AND MAGNETIC RECORDING/REPRODUCING DEVICE

(75) Inventors: Akira Ishibashi, Hokkaido (JP); Hideo Kaiju, Hokkaido (JP)

(73) Assignee: NATIONAL UNIVERSITY CORPORATION HOKKAIDO UNIVERSITY, Hokkaido (JP)

(21) Appl. No.: 13/379,564

(22) PCT Filed: Jun. 25, 2010
(86) PCT No.: PCT/JP2010/061290

§ 371 Date: Feb. 3, 2012

(30) Foreign Application Priority Data
Jun. 30, 2009 (JP) 2009-154644

(51) Int. Cl. G11B 5/33; G01Q 70/16; G01Q 20/00

(52) U.S. Cl. 428/815; 850/5; 850/60; 156/182

(57) ABSTRACT

At least two thin pieces, each of which is composed of a structure having conductor layers and dielectric layers laminated therein, are stacked such that those layers intersect each other and that the edges of the conductor layers face with a gap, and the stacked structure is cut along a dividing plane passing the intersecting section of the layers or the vicinity of the intersecting section and dividing the intersection angle of the layers to produce a probe. A magnetic head is produced using magnetic layers as conductor layers.

### TECHNICAL FIELD

The present invention relates to a probe, a method for producing a probe, a probe microscope, a magnetic head, a method for producing a magnetic head, and a magnetic record and reproduction apparatus, and particularly relates to a probe suitable for use for observation of a micro area, a probe microscope using the probe, or a magnetic head suitable for use for high density magnetic recording, and a magnetic record and reproduction apparatus using the magnetic head.

### BACKGROUND ART

In recent years, for a probe of a micro area of a surface of a sample, a scanning microscope such as a scanning tunneling microscope and an atomic force microscope, etc. is often used.

On the other hand, in a magnetic record and reproduction apparatus, with further improvement of recording density of magnetic recording media, a magnetic head which enables to make high density recording is requested. As a method for producing a magnetic head which enables to make such high density recording, conventionally a top-down method applying a fine processing technology is used (for example, see Japanese Patent Laid-open Publication No. 270322/1997, Japanese Patent Laid-open Publication No. 2000-149214, and Japanese Patent Laid-open Publication No. 2005-122838).

In a conventional scanning probe microscope, a probe having an atomic-scale sharp front edge is used. However, it was difficult to produce such a probe with high controllability and productivity. Further, as the probe was fragile, it was difficult to handle.

On the other hand, in a method for producing a magnetic head using a conventional fine processing technology, it is very difficult to produce a magnetic head with a gap length of nanometer or sub-nanometer order.

In recent years, there is proposed an element wherein two thin pieces, each of which is composed of a periodic structure having conductor layers and dielectric layers, are stacked such that those layers intersect each other, and that the edges of the conductor layers face each other with a gap (see International Publication No. 06/035610 and International Publication No. 09/041239). However, these elements cannot be used as a probe probing a surface of a sample or a magnetic head. Also, there is proposed a magnetic head wherein striped metal magnetic films and insulator thin films are arranged alternately (see Japanese Patent Laid-open Publication No. 277612/1987). The magnetic head is formed by forming a laminated film wherein metal magnetic films and insulator thin films are laminated alternately on the first nonmagnetic substrate, joining the second nonmagnetic substrate on the laminated film, and cutting the joined body along the direction at right angle to the laminated film. Also, there is proposed a thin film magnetic head wherein a lower magnetic pole layer, an upper magnetic pole layer, a recording gap layer and a thin film coil are provided and the thin film coil is taken up in spirals around the upper magnetic pole layer in a state wherein the thin film coil is insulated for the lower magnetic pole layer and the upper magnetic pole layer (see Japanese Patent Laid-open Publication No. 2004-310975). However, it is very difficult to record and reproduce a signal for a micro-recording area of nanometer or sub-nanometer order size by these magnetic heads.

Therefore, a subject to be solved by the present invention is to provide a probe with a gap length of nanometer or sub-nanometer order and with durability that can be easily obtained, and can probe a surface of a micro area of nanometer or sub-nanometer order size, and a method for producing the probe, and a probe microscope using such a probe.

Another subject to be solved by the present invention is to provide a magnetic head with a gap length of nanometer or sub-nanometer order and with durability that can be easily obtained, and can record and reproduce a signal for a micro recording area of nanometer or sub-nanometer order size, and a method for producing the magnetic head, and a magnetic record and reproduction apparatus using such a magnetic head.

The aforementioned subjects and the other subjects will be apparent from these descriptions referring to the attached drawings.

### DISCLOSURE OF INVENTION

To solve the aforementioned subjects, according to the present invention, there is provided a probe wherein one or more pseudo zero-dimensional area formed by facing conductors is formed in the two-dimensional plane, and the pseudo zero-dimensional area is exposed on a surface, thereby making it possible to detect a signal from the direction intersecting to the surface.

Here, the pseudo zero-dimensional area means an area of nanometer or sub-nanometer order size that can be regarded as a zero-dimensional area pseudically, and for example, the size of an area is 20 nm or less, typically 10 nm or less.

Further, according to the present invention, there is provided a method for producing a probe comprising steps of:

forming a stacked structure by stacking at least two thin pieces, each of which is composed of a structure having conductor layers and dielectric layers laminated therein, such that those layers intersect each other and the edges of the conductor layers face with a gap to form one or more pseudo zero-dimensional area; and

cutting the stacked structure along a diving plane passing the intersecting section of the layers or the vicinity of the intersecting section and dividing the intersecting angle of the layers.

Further, according to the present invention, there is provided a probe microscope comprising a probe wherein one or more pseudo zero-dimensional area formed by facing conductors is formed in the two-dimensional plane, and the pseudo zero-dimensional area is exposed on a surface, thereby making it possible to detect a signal from the direction intersecting to the surface.

Further, according to the present invention, there is provided a magnetic head wherein one or more pseudo zero-dimensional area formed by facing magnetic materials is formed in the two-dimensional plane, and the pseudo zero-dimensional area is exposed on a surface, thereby making it possible to detect a signal from the direction intersecting to the surface.

Further, according to the present invention, there is provided a method for producing a magnetic head comprising steps of:

forming a stacked structure by stacking at least two thin pieces, each of which is composed of a structure having magnetic layers and dielectric layers laminated therein, such that those layers intersect each other and the edges of the magnetic layers face with a gap to form one or more pseudo zero-dimensional area; and

cutting the stacked structure along a diving plane passing the intersecting section of the layers or the vicinity of the intersecting section and dividing the intersecting angle of the layers.

Further, according to the present invention, there is provided a magnetic record and reproduction apparatus comprising a magnetic head wherein one or more pseudo zero-dimensional area formed by facing magnetic materials is formed in the two-dimensional plane, and the pseudo zero-dimensional area is exposed on a surface, thereby making it possible to detect a signal from the direction intersecting to the surface.

In the probe, typically the pseudo zero-dimensional area formed by stacking at least two thin pieces, each of which is composed of a structure having conductor layers and dielectric layers laminated therein, such that those layers intersect each other, and that the edges of the conductor layers face with a gap, is formed in the two-dimensional plane, and the pseudo zero-dimensional area is exposed on the surface, thereby making it possible to detect a signal from the direction that intersect at right angle to the surface. Or, in the probe, typically, at least two thin pieces having a structure that a conductor layer is sandwiched by dielectric layers are stacked such that those layers intersect each other and that the edges of the conductor layers face with a gap, and the pseudo zero-dimensional area is exposed on a surface made of the two-dimensional plane including the sides of at least two thin pieces. Or, the probe has typically a shape formed by cutting a stacked structure wherein at least two thin pieces, each of which is composed of a structure having conductor layers and dielectric layers laminated therein, are stacked such that those layers intersect each other, and that the edges of the conductor layers face with a gap along a dividing plane passing the intersecting section of the layers or the vicinity of the intersecting section and dividing the intersecting angle of the layers. The structure having conductor layers and dielectric layers laminated therein is typically a periodic structure having conductor layers and dielectric layers laminated therein, but is not limited to this. The number of the conductor layers and dielectric layers included in a thin piece is not limited, and is selected as necessary. Also, when the plural conductor layers or the plural dielectric layers exist in a thin piece, their thickness may be whether identical or non-identical.

In the magnetic head, typically the pseudo zero-dimensional area formed by stacking at least two thin pieces, each of which is composed of a structure having magnetic layers and dielectric layers laminated therein, such that those layers intersect each other and the edges of the magnetic layers face with a gap, is formed in the two-dimensional plane and the pseudo zero-dimensional area is exposed on a surface, thereby making it possible to detect a signal from the direction that intersect at right angle to the surface. Or, in the magnetic head, typically, at least two thin pieces having a structure that a magnetic layer is sandwiched by dielectric layers are stacked such that those layers intersect each other and that the edges of the magnetic layers face with a gap, and the pseudo zero-dimensional area is exposed on a surface made of the two-dimensional plane including the sides of at least two thin pieces. Or, the magnetic head has typically a shape formed by cutting a stacked structure wherein at least two thin pieces, each of which is composed of a structure having magnetic layers and dielectric layers laminated therein, are stacked such that those layers intersect each other, and that the edges of the magnetic layers face with a gap along a dividing plane passing the intersecting section of the layers or the vicinity of the intersecting section and dividing the intersecting angle of the layers. The structure having magnetic layers and dielectric layers laminated therein is typically a periodic structure having magnetic layers and dielectric layers laminated therein, but is not limited to this. The number of the magnetic layers and dielectric layers included in a thin piece is not limited, but is selected as necessary. Also, when the plural magnetic layers or the plural dielectric layers exist in a thin piece, the thickness of these layers may be whether identical or non-identical.

In the probe or the magnetic head, the dividing plane dividing the stacked structure wherein at least two thin pieces, each of which is composed of a structure having conductor layers and dielectric layers laminated therein or a structure having magnetic layers and dielectric layers laminated therein, are stacked is typically a bisecting plane of the intersection angle of the layers, but is not limited to this. Also, typically, at least the two thin pieces are stacked such that those layers intersect each other at the angle of 90°, but is not limited to this. The conductor layers of the probe is typically made of metal, and as metal, for example, gold, palladium, platinum, titanium etc., and various kinds of alloys can be used, and is selected as necessary. Also, the magnetic layers of the magnetic head is typically made of ferromagnetic materials, and as ferromagnetic materials, various kinds of materials, for example, nickel, iron, nickel-iron alloy, iron-nickel-chromium alloy, etc. can be used and is selected as necessary. Also, the dielectric layers of the probe or the magnetic head is made of an organic or inorganic dielectric material. As organic dielectric material, various polymers (resin), etc. such as, for example, polyethylene naphthalate, polyethylene terephthalate, polytrimethylene terephtalate, polybutylene terephthalate, polybutylene naphthalate, polyimide, etc. can be used, and as inorganic dielectric materials, for example, silicon dioxide and aluminum oxide, etc. can be used. The thickness of the conductor layer or magnetic layer (the thickness of in-plane direction of a thin piece) is selected as necessary, but typically, is 0.2 nm or more and 100 nm or less. Here, 0.2 nm, the minimum thickness, is the minimum thickness which enables to make a film by a vacuum evaporation method, etc. The thickness of the dielectric layer (the thickness of in-plane direction of a thin piece) is not limited, and is selected as necessary, but typically, is 0.2 nm and more and 50 μm or less. The minimum thickness of 0.2 nm of the dielectric layer is also the minimum thickness which enables to make a film by vacuum evaporation method, etc.

A method for producing a thin piece which is composed of the structure having the conductor layers and dielectric layers laminated therein, or a thin piece which is composed of the structure having the magnetic layers and dielectric layers laminated therein, is not especially limited. For example, a disc-shaped roll wherein the conductor layers and the dielectric layers are formed alternately and periodically in the radial direction, or a disc-shaped roll wherein the magnetic layers and dielectric layers are formed alternately and periodically in the radial direction is produced by a roll-to-roll process. The thin piece can be produced by cutting the roll. The number of stacked layers of a thin piece is selected as necessary. The thin piece is typically a square or a rectangle, but is not limited to these. Also, the size and thickness of the thin piece is selected as necessary. Further, the thin piece to be stacked may be either identical or non-identical, for example, two thin pieces having different interval of conductor layers each other may be stacked, or two thin pieces having different interval of magnetic layers each other may be stacked.

According to the present invention, one or more pseudo zero-dimensional area formed by facing conductors or magnetic materials is formed in the two-dimensional plane, and the pseudo zero-dimensional area is exposed on the surface, thereby making it possible to detect a signal from the direction intersecting to the surface. Therefore, a probe which enables to probe a surface of a micro area of nanometer or sub-nanometer order size or a magnetic head which enables to record and reproduce of a signal for a micro recording area of nanometer or sub-nanometer order size can be realized. Also, these probes and magnetic heads can be produced easily by only stacking at least two thin pieces produced by a roll-to-roll process, etc. and cutting them. In this case, when thin pieces are stacked, a spacer layer of a nanometer order thickness is sandwiched between them, and when a thin piece is produced, the upper surface of the conductor layers or the magnetic layers is dented to a nanometer order distance from the both major surfaces of the thin piece, thereby making it possible to produce the probe or the magnetic head with a gap length of nanometer or sub-nanometer order easily. The probe or the magnetic head to be produced by the method has high mechanical strength and is easy to handle because they are composed of the stacked structure having thin pieces stacked therein.

### BRIEF DESCRIPTION OF DRAWINGS

FIGS. 1A and 1B are a front view and a side view respectively showing a vacuum evaporator used for producing a magnetic head according to the first embodiment of the present invention.

FIG. 2 is a plan view showing a disc-shaped roll produced by using the vacuum evaporator shown in FIGS. 1A and 1B.

FIG. 3 is a perspective view showing a thin piece cut down from the disc-shaped roll shown in FIG. 2.

FIG. 4 is a perspective view showing a stacked structure wherein two thin pieces shown in FIG. 3 are stacked such that those layers intersect each other at the angle of 90°.

FIG. 5 is a plan view showing a stacked structure wherein two thin pieces shown in FIG. 3 are stacked such that those layers intersect each other at the angle of 90°.

FIGS. 6A and 6B are a perspective view and a side view respectively showing an intersecting section of a magnetic film of a thin piece and a magnetic film of the other thin piece of the stacked structure shown in FIG. 4.

FIG. 7 is a plan view for explaining a cutting method of the stacked structure shown in FIG. 4.

FIG. 8 is a perspective view showing a magnetic head according to the first embodiment of the present invention to be obtained by cutting the stacked structure shown in FIG. 4.

FIG. 9 is a side view showing a magnetic head according to the first embodiment of the present invention to be obtained by cutting the stacked structure shown in FIG. 4.

FIG. 10 is a bottom view showing a magnetic head according to the first embodiment of the present invention to be obtained by cutting the stacked structure shown in FIG. 4.

FIG. 11 is a perspective view showing a shape of a head part in a magnetic head according to the first embodiment of the present invention to be obtained by cutting the stacked structure shown in FIG. 4, and two magnetic films constituting the head part.

FIG. 12 is a schematic view showing schematically a state of recording or reproduction for magnetic recording media using a magnetic head according to the first embodiment of the present invention.

FIG. 13 is a cross sectional transmission electron microscopic photograph of a sample wherein a 20-nm-thick nickel thin film is formed on a PEN film.

FIG. 14 is a bottom view showing a magnetic head according to the second embodiment of the present invention.

FIG. 15 is a perspective view showing a thin piece used for producing a magnetic head according to the third embodiment of the present invention.

FIG. 16 is a perspective view showing a stacked structure wherein two thin pieces shown in FIG. 15 are stacked such that those layers intersect each other at the angle of 90°.

FIG. 17 is a bottom view showing a magnetic head according to the third embodiment of the present invention to be obtained by cutting the stacked structure shown in FIG. 16.

FIG. 18 is a perspective view showing a thin piece used for producing a probe according to the fifth embodiment of the present invention.

FIG. 19 is a perspective view showing a probe according to the fifth embodiment of the present invention to be obtained by cutting the stacked structure wherein two thin pieces shown in FIG. 18 are stacked such that those layers intersect each other at the angle of 90°.

FIG. 20 is a perspective view showing a thin piece used for producing a probe according to the eighth embodiment of the present invention.

FIG. 21 is a perspective view showing a probe according to the eighth embodiment of the present invention to be obtained by cutting the stacked structure wherein two thin pieces shown in FIG. 20 are stacked such that those layers intersect each other at the angle of 90°.

FIG. 22 is a perspective view showing a probe according to the ninth embodiment of the present invention to be obtained by cutting the stacked structure wherein a thin piece shown in FIG. 18 and a thin piece shown in FIG. 20 are stacked such that those layers intersect each other at the angle of 90°.

### BEST MODE FOR CARRYING OUT THE INVENTION

The best mode for carrying out the invention (hereafter refer to embodiment) is explained in detail below with reference to the accompanying drawings. In all drawings of the embodiment, the same reference numerals are given to the same parts.

First, the first embodiment of the present invention is explained. In the first embodiment, a magnetic head and a method for producing the magnetic head are explained.

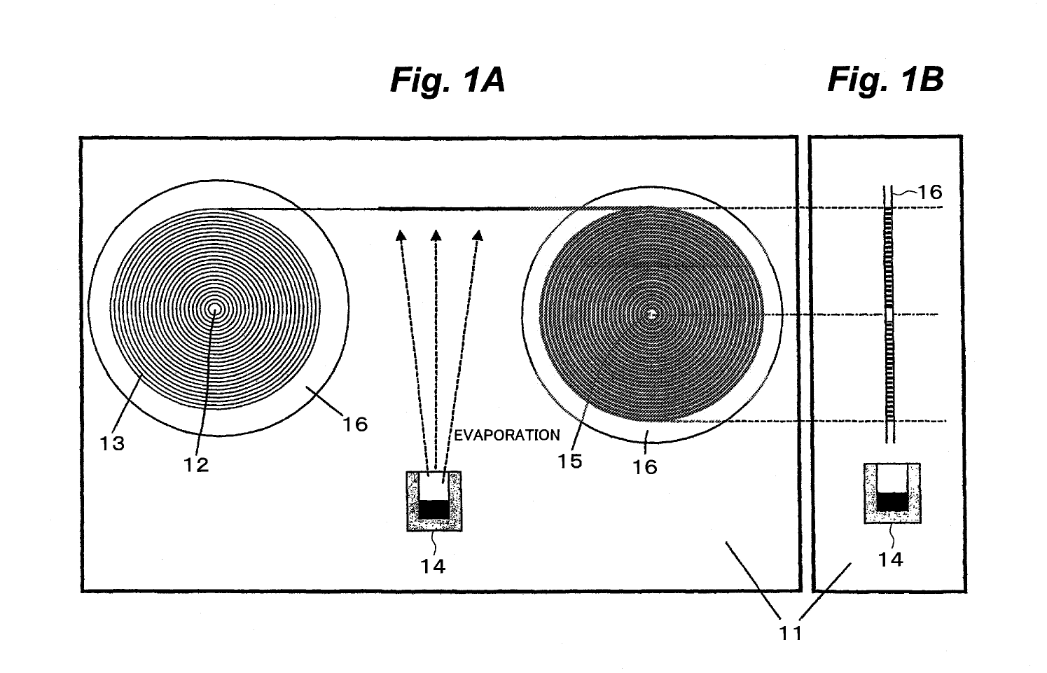

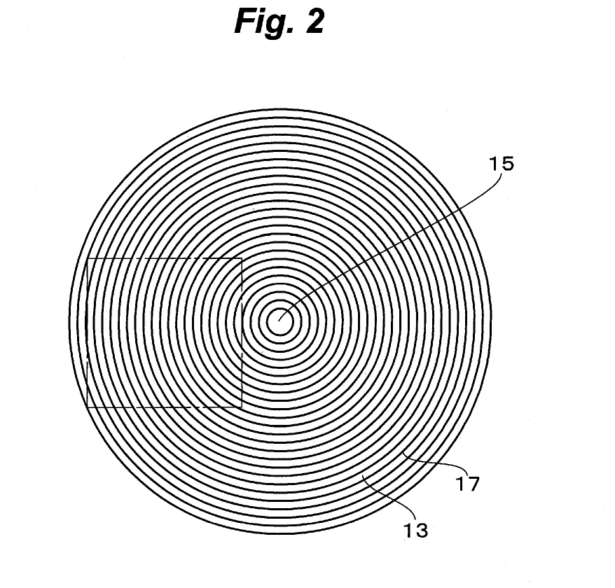

FIGS. 1A and 1B are a front view and a side view respectively of a vacuum chamber 11 of a vacuum evaporator.

As shown in FIGS. 1A and 1B, in the first embodiment, a dielectric layer 13 such as narrow and thin flat tape shaped resin base film, etc. is taken up to a roller 12. After forming a magnetic film (not illustrated) thinly on one side of the dielectric layer 13 by evaporating a metal magnetic material from an evaporation source 14, the dielectric layer 13 with the magnetic film is taken up by a take up roller 15. Reference numeral 16 shows a support plate keeping the dielectric layer 13 from both sides. Here, the thickness of the dielectric layer 13 is, for example, 0.2 nm or more and 50 μm or less, and the thickness of the magnetic film is 0.2 nm or more and 100 nm or less, but is not limited to this.

By being taken up the dielectric layer 13 with the magnetic film by the take up roller 15 as explained above, as shown in FIG. 2, a spiral structure wherein the dielectric layer 13 and the magnetic film 17 are alternately laminated in the radial direction is formed. Here, in FIG. 1A, for convenience of illustration, a spiral structure is substituted by a concentric ring structure.

Next, as necessary, both sides of the disc-shaped spiral structure are flattened by polishing using a chemical mechanical polishing (CMP) method, etc.

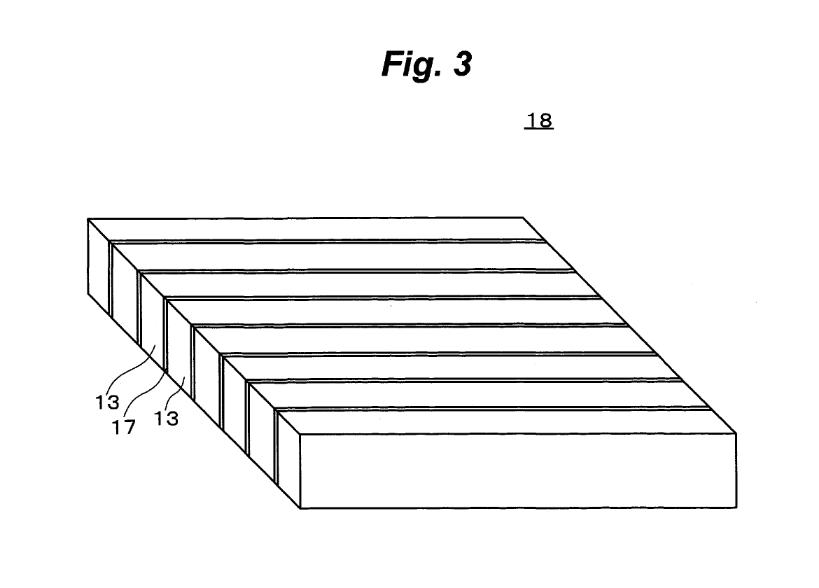

Next, a part of the disc-shaped spiral structure, both sides of which has been polished in this way, is cut down as shown by a dot and dashed-lined quadrangle(a rectangle or a square) of FIG. 2. In FIG. 3, a thin piece 18 cut down as explained above is shown. As shown in FIG. 3, in the thin piece 18, the stripe-shaped dielectric layer 13 and magnetic film 17 are formed alternately and periodically in-plane direction. Here, the dielectric layer 13 and magnetic film 17 of the thin piece 18 have a spiral structure strictly speaking and is curved, but when a period of the magnetic film 17 is selected to be small enough, for example, from 10 nm to 1 μm, these dielectric layers 13 and magnetic film 17 can be regarded as extending to a linear fashion. In FIG. 3, as an example, a case where the number of the magnetic film 17 of the thin piece 18 is 7, but is not limited to this.

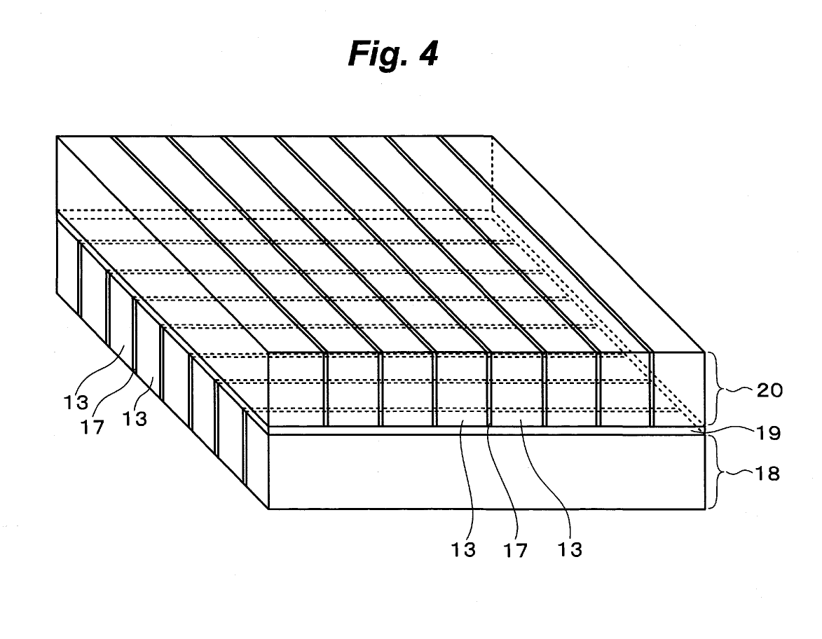

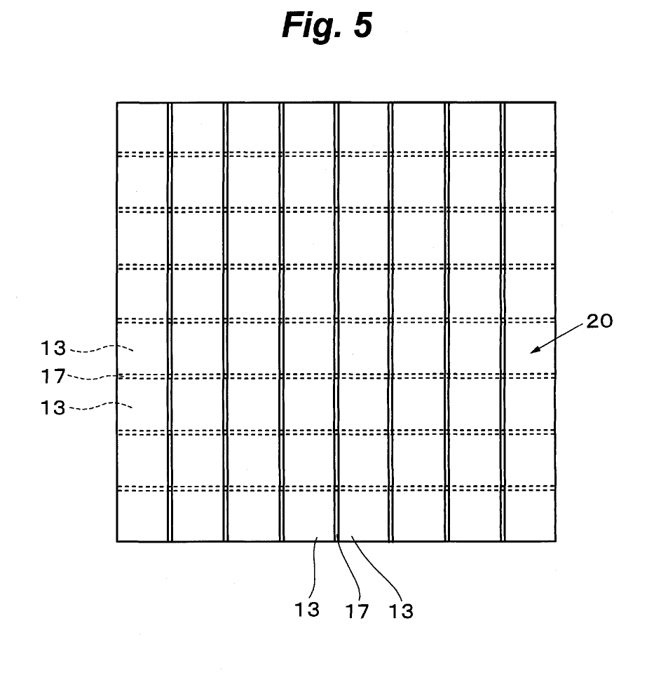

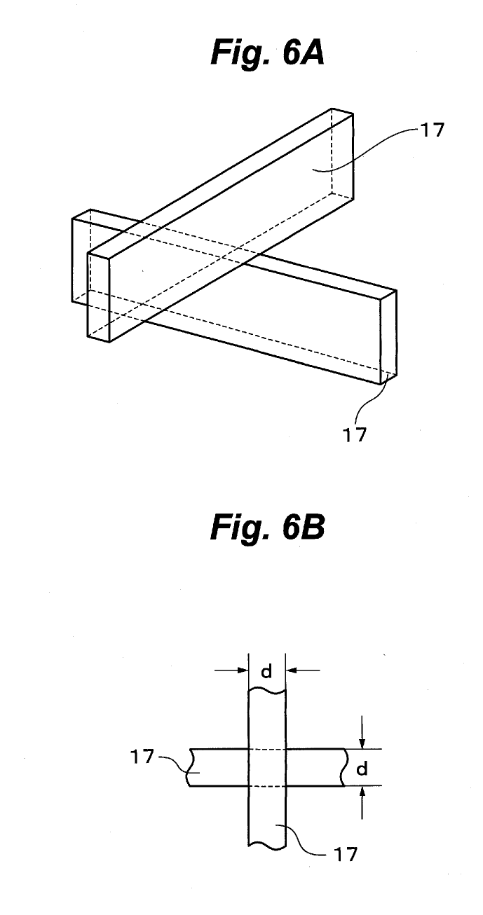

Next, as shown in FIG. 4, another thin piece 20 having the same structure with the thin piece 18 is stacked on the thin piece 18 through a spacer layer 19 made of dielectric material such that those dielectric layer 13 and magnetic film 17 intersect each other at the angle of 90°, and that the edges of the magnetic film 17 face to form a stacked structure. Here, a planar shape of the thin piece 18 is to be a square. A plan view of the stacked structure is shown in FIG. 5. FIGS. 6A and 6B are a perspective view and a plan view respectively showing an intersecting section of one magnetic film 17 of the thin piece 18 and one magnetic film 17 of the thin piece 20, omitting illustrations of the dielectric layer 13 and spacer layer 19, and enlarging the illustration. As shown in FIG. 6B, the size of the intersecting section of one magnetic film 17 of the thin piece 18 and one magnetic film 17 of the thin piece 20 is a square with d in length of its side. The thickness of the spacer layer 19 is selected as equal to a gap length of a head part. The spacer layer 19 may be formed by dielectric material such as SiO₂ or polymer material, etc., for example. The spacer layer 19 may be formed on one side of the thin piece 18 or thin piece 20. For the formation of the spacer layer 19, according to the material of the spacer layer 19, an appropriate method, for example, a vacuum evaporation method, a sputtering method, a chemical vapor deposition (CVD) method, a metal organic chemical vapor deposition (MOCVD) method, a coating method, etc. can be used.

When forming the stacked structure by stacking the thin pieces 18 and 20, for example, the thin piece 18 is put on a support plate, then the thin piece 20 is put on it, and pressed to closely adhere the thin pieces 18 and 20 each other through the spacer layer 19. In the state, a support plate made of, for example, polymethylmethacrylate (PMMA), etc. is stuck for the four sides (end face) of the stacked structure of the thin pieces 18 and 20, by adhesive, for example, epoxy-based adhesive, etc. Then, after releasing the press for the thin piece 20, a support plate made of, for example, PMMA, etc. is stuck for the support plate stuck to both sides of the stacked structure of the thin pieces 18 and 20 and sides of the stacked structure by adhesive, for example, epoxy-based adhesive. In this way, the stacked structure wherein the thin pieces 18 and 20 are closely-adhered each other through the spacer layer 19 is formed.

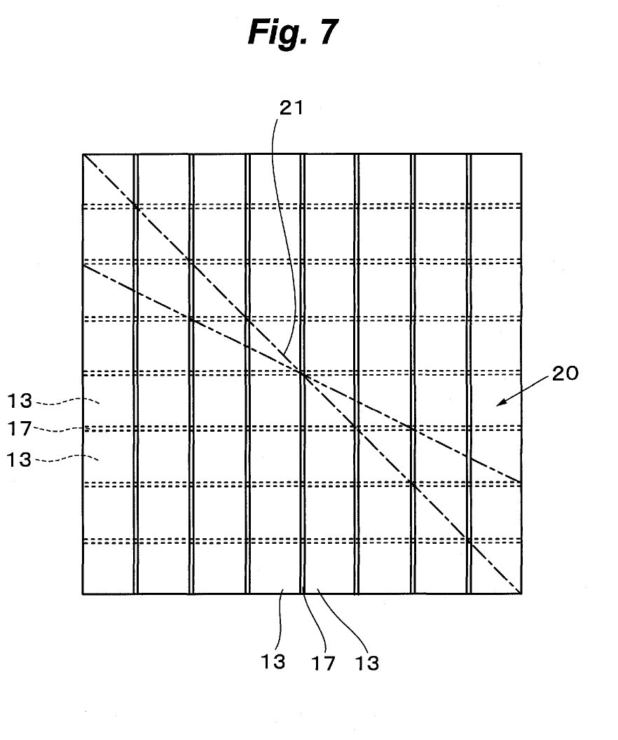

Next, as shown in FIG. 7, the stacked structure wherein the thin pieces 18 and 20 are closely-adhered each other through the spacer layer 19, and the stacked structure is fully enclosed by the support plates is cut along a bisecting plane 21 passing the intersecting section of the dielectric layer 13 and the magnetic film 17 of the thin pieces 18 and 20 and bisecting the intersection angle of the dielectric layer 13 and the magnetic film 17 (making angle of 45° for extending direction of the dielectric layer 13 and the magnetic film 17 of the thin pieces 18 and 20), and is two-divided. Various methods can be used for cutting, and the cutting method is selected as necessary. For example, the stacked structure may be cut using pulsed laser beam by femtosecond laser.

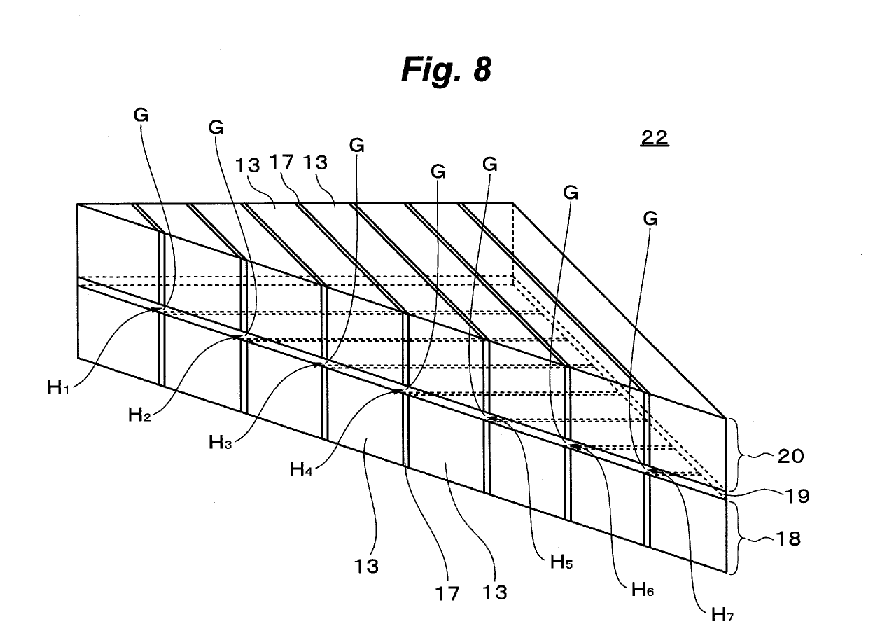

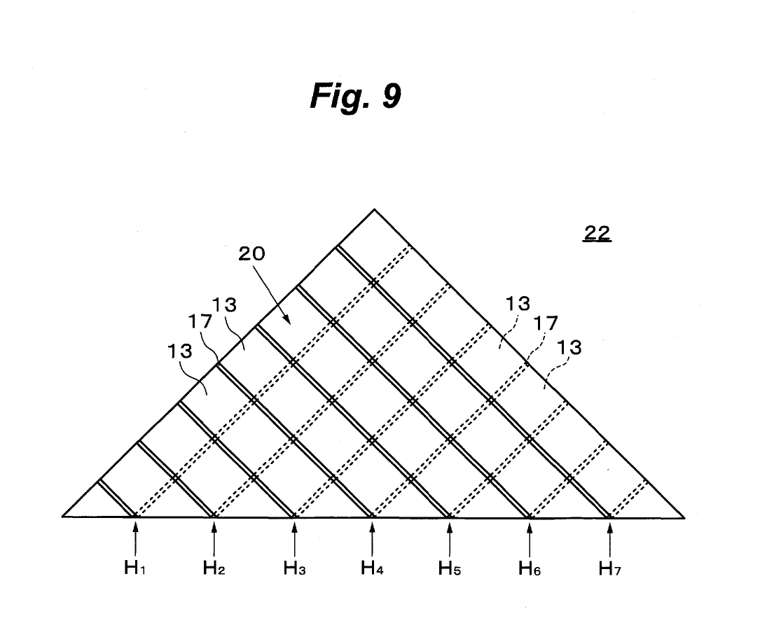

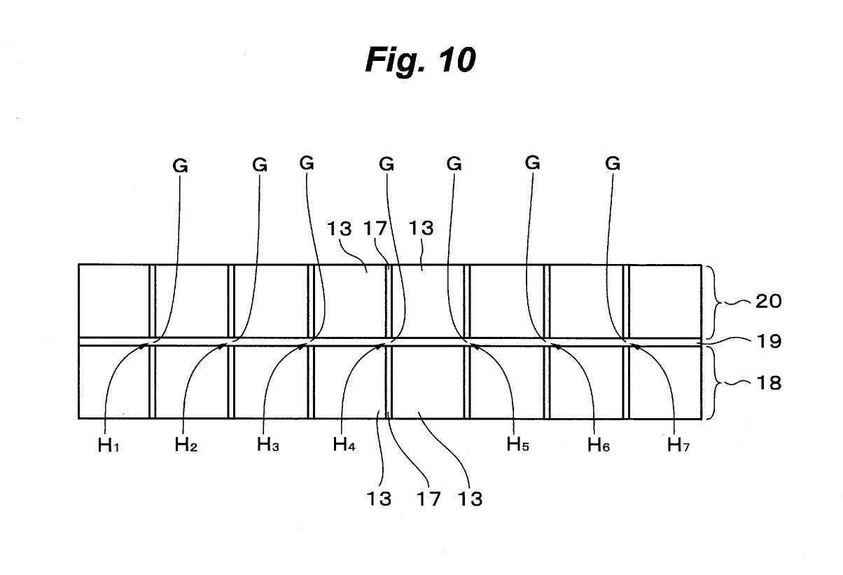

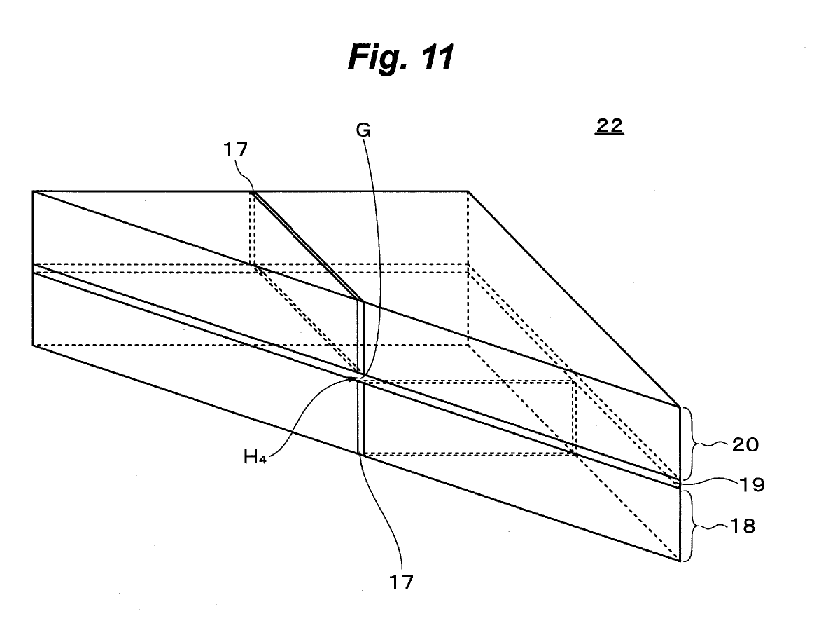

One triangular prism fragment two-divided by the method is shown in FIG. 8. Also, the side view of the triangular prism fragment is shown in FIG. 9, and the bottom surface made of a cut plane is shown in FIG. 10. The triangular prism fragment constructs a magnetic head 22. As shown in FIGS. 8 to 10, in the magnetic head 22, at the bottom surface made of a cut plane exposed on the surface, the plural head parts (for example, head parts H₁ to H₇) are arranged in equal distance in a linear fashion. Each head part has a structure wherein the edge of the magnetic film 17 of the thin piece 18 and the edge of the magnetic film 17 of the thin piece 20 face with a gap G formed by the spacer layer 19 in the direction of width and intersect each other at the angle of 90° and the intersecting section forms the gap G as the pseudo zero-dimensional area. In other words, in the magnetic head 22, two thin pieces 18 and 20 having a structure wherein the magnetic film 17 is sandwiched by the dielectric layers 13 are stacked such that those layers intersect each other, and the edges of the magnetic films 17 face with the gap G, and on the surface (bottom surface made of cut planes of the triangular prism fragment) made of the two-dimensional plane including sides of the two thin pieces 18 and 20, and the gap G as the pseudo zero-dimensional area is exposed. In order to show the details of a shape of the magnetic film 17 in the magnetic head 22, a shape of a pair of the magnetic films 17 structuring the head part H₄ is shown in FIG. 11 as an example. In FIG. 11, the illustrations of head parts H₁ to H₃ and H₅ to H₇ and the magnetic film 17 structuring these head parts H₁ to H₃ and H₅ to H₇ are omitted.

In each head part of the magnetic head 22, electric current can be flown between the magnetic film 17 of the thin piece 18 and the magnetic film 17 of the thin piece 20 by the outside power supply. In this case, as each head part has a structure wherein the edge of the magnetic film 17 of the thin piece 18 and the edge of the magnetic film 17 of the thin piece 20 face, it is possible to concentrate lines of magnetic force in the gap G formed by the spacer layer 19 and to record and reproduce easily (see a related explanation of FIG. 10B of International Publication No. 06/035610).

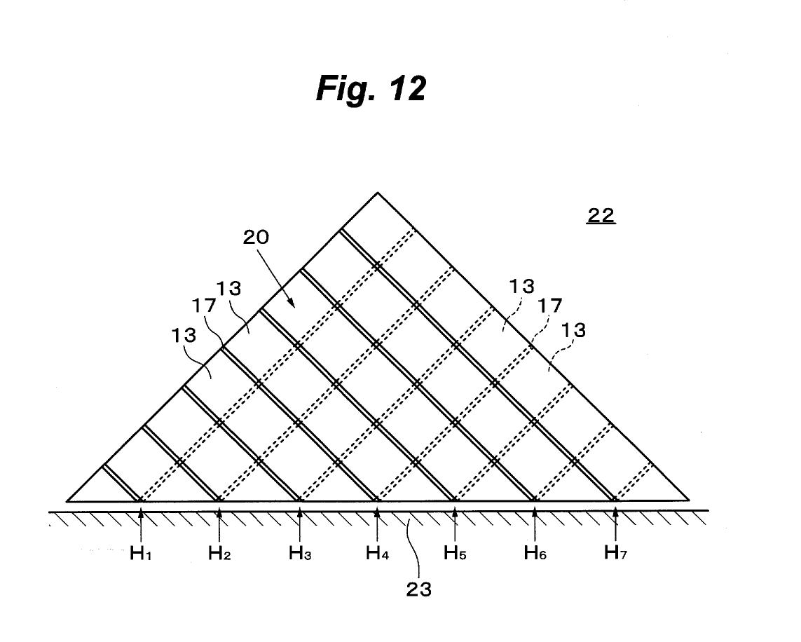

When using the magnetic head 22 for a magnetic record and reproduction apparatus, a manner of recording or reproducing for magnetic recording media by the magnetic head 22 is shown in FIG. 12. As shown in FIG. 12, the magnetic head 22 is supported by predetermined support members not illustrated and head parts of the bottom surface of the magnetic head 22 (for example, head parts H₁ to H₇) are made approach or made contact to the direction intersecting to the surface of the magnetic recording media 23, for example, from the direction that intersect at right angle to the surface, and record or reproduction is performed. In this case, at the plural head parts record or reproduction can be performed at the same time.

An example is explained.

Using a polyethylene naphthalate (PEN) film (trade name: TEONEX Q65) having 5-mm-width and 100-μm-thickness supplied by Teijin DuPont Japan Limited as the dielectric layer 13, the PEN film is cut down to 2-mm-width by using a slitter with the film-rolling-up system in clean environment. On the PEN film having 2-mm-width and 100-μm-thickness prepared by the process, while forming a nickel thin film as the magnetic film 13 by a vacuum evaporation method, the film is taken up by a take up roll. Forming a nickel thin film, for example, is made by the same process by the same vacuum evaporator as described in the International Publication No. 09/041239. The thickness of the nickel thin film is 17 nm. Next, from a roll taking up the PEN film formed the nickel thin film, a quadrangle-shaped thin piece laminated body shown by a dot and dashed line in FIG. 2 is cut down. Thus, two laminated bodies are cut down, and a SiO₂ film as the spacer layer 19 is formed on a surface of the laminated body by a vacuum evaporation method. The thickness of the SiO₂ film is 2 nm. Next, these two laminated bodies are stuck such that the edges of these nickel thin films face each other and intersect at the angle of 90° each other. In this case, sticking of two laminated bodies is made by adhering the PMMA plate by epoxy-based adhesive on the four sides of the laminated body under the condition that these laminated bodies are pressed and adhered, and thereafter the PMMA plates adhered on up-and-down surfaces of these laminated bodies and sides of these laminated bodies is adhered on the PMMA plate by epoxy-based adhesive.

Next, two laminated bodies fully enclosed by the PMMA plates formed by the method is cut down along a bisecting plane 21 shown by a dot and dashed line in FIG. 7, and a multi-type magnetic head is produced.

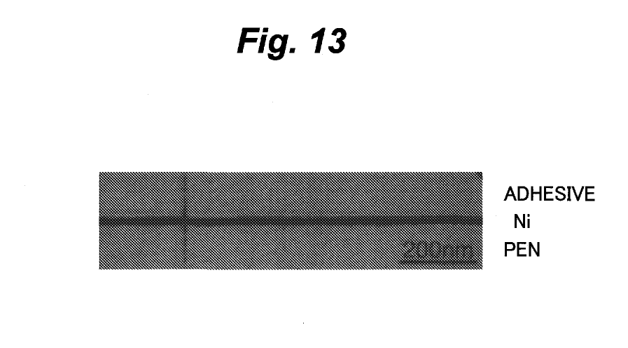

As an example, a cross sectional transmission electron microscopic image (a cross sectional TEM image) of the sample having the 20-nm-thick nickel thin film formed on the PEN film by vacuum evaporation method is shown in FIG. 13. In FIG. 13, the adhesive covering the surface of the nickel thin film shows an adhesive used in adhering a support plate (not illustrated) to the side of the nickel thin film when preparing the sample for cross sectional TEM observation. By FIG. 13, it is understood that nickel atoms do not penetrate into the PEN film, clear nickel/PEN interface is formed, and the nickel/PEN interface is very flat.

As described above, according to the first embodiment, it is possible to obtain easily a multi-type magnetic head 22 wherein the plural head parts structured such that the magnetic film 17 of the thin piece 18 and the magnetic film 17 of the thin piece 20 face with the gap G having the gap length determined by the thickness of the spacer layer 19 in the direction of its width, are arranged in equal distance in linear fashion. In the magnetic head 22, by selecting the thickness of the spacer layer 19 to nanometer or sub-nanometer order, a gap length of each head part can be made quite small as nanometer or sub-nanometer order. For this, by the magnetic head 22, it is possible to keep up fully with the trend of ultra-high recording density of magnetic recording media. Also, as the magnetic head 22 has the plural head parts, record and reproduction can be made for the plural points of the surface of magnetic record media at the same time, and the speed of record and reproduction can be improved drastically. Further, as the magnetic head 22 is made of the stacked structure having the two thin pieces 18 and 20 stacked, not only its mechanical strength is high, lifetime is long, but also is easy to handle.

Next, a magnetic head according to the second embodiment of the present invention is explained.

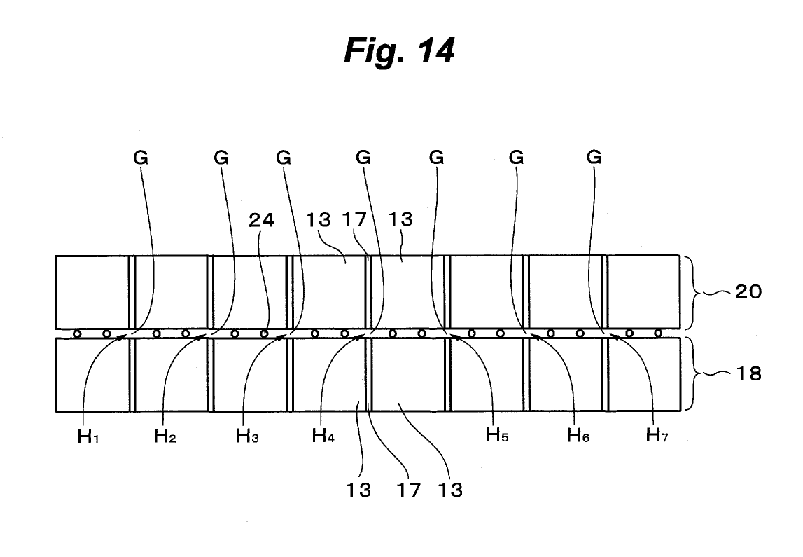

In the second embodiment, instead of the spacer layer 19 used in the first embodiment, a micro spherical ball is used. More specifically, as shown in FIG. 14, on the thin piece 18, another thin piece 20 having the same structure as the thin piece 18 is stacked through many spherical balls 24 such that their dielectric layer 13 and magnetic film 17 intersect each other at the angle of 90° to form the stacked structure, and the stacked structure is cut to produce the magnetic head 22. The diameter of the ball 24 is selected as equal to the gap length of the head part. As materials of the ball 24, for example, plastic, etc. such as polystyrene, etc. can be used. The ball 24 is sprayed on one surface of the thin piece 18 or the thin piece 20. The other respects are the same as the first embodiment.

According to the second embodiment, various advantages as the first embodiment can be obtained.

Next, a magnetic head according to the third embodiment of the present invention is explained.

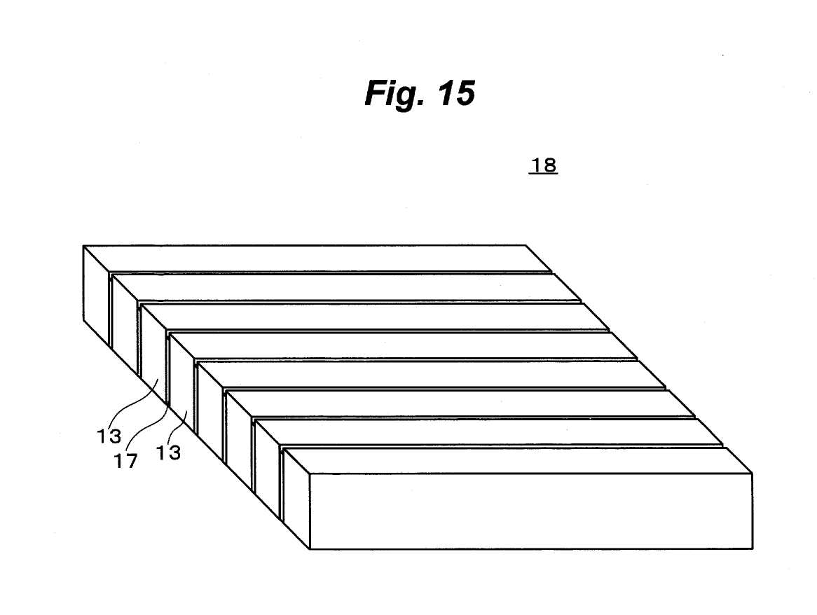

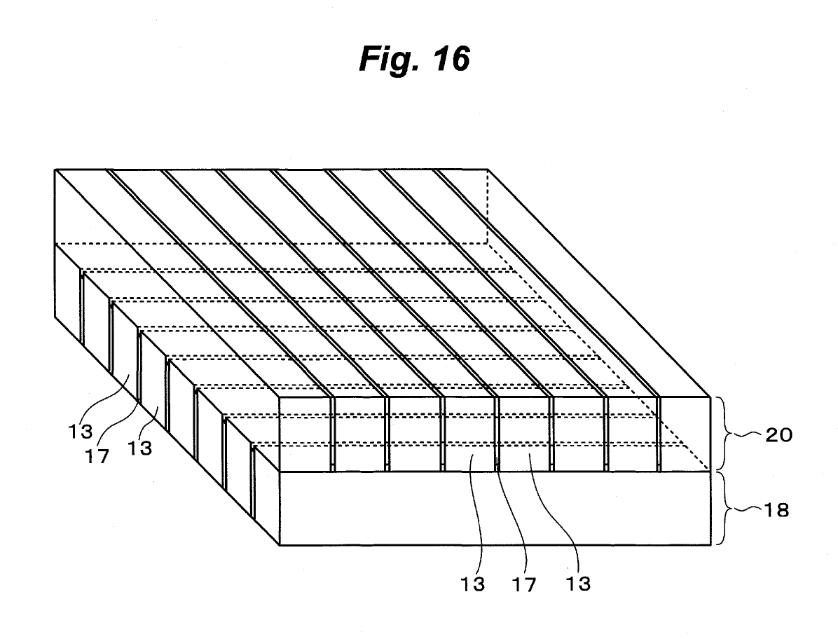

In the third embodiment, the spacer layer 19 used in the first embodiment is not used. Alternatively, the upper surface of the magnetic film 17 exposed on the major surface of the thin pieces 18 and 20 is dug in a predetermined depth from the major surface, especially is dug a distance corresponding to ½ of the gap length. For this, when the both sides of the disc-shaped spiral structure shown in FIG. 2 is polished, for example, by a chemical mechanical polishing method, polishing condition is selected so that the upper part of the magnetic film 17 is dissolved by action of alkali solution used for polishing. FIG. 15 shows the state that the upper surface of the magnetic film 17 exposed on the major surface of the thin piece 18 is dug in a distance corresponding to ½ of the gap length. And as shown in FIG. 16, the stacked structure is formed by stacking the thin piece 20 on the thin piece 18 such that a major surface wherein the upper surface of the magnetic film 17 of the thin piece 18 is dug in a distance corresponding to ½ of the gap length, and a major surface wherein the upper surface of the magnetic film 17 of the thin piece 20 is dug in a distance corresponding to ½ of the gap length contact each other.

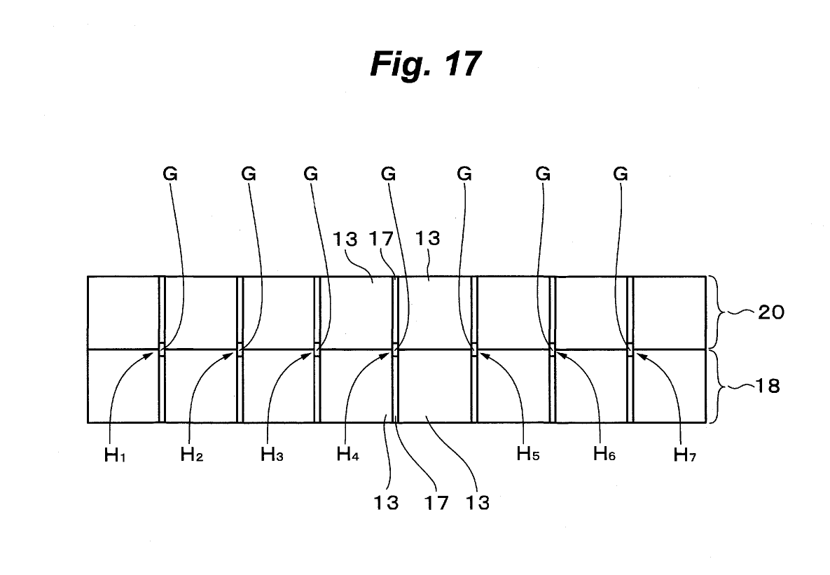

After this, as the same as the first embodiment, the stacked structure is cut and is two-divided, and a magnetic head 22 is produced. The bottom surface made of a cut plane of the magnetic head 22 is shown in FIG. 17.

The other respects are the same as the first embodiment.

According to the third embodiment, various advantages as the same as the first embodiment can be obtained.

Next, a magnetic head according to the fourth embodiment of the present invention is explained.

In the fourth embodiment, as the same as the first embodiment, after forming the stacked structure having the thin pieces 18 and 20 stacked, the stacked structure is cut along the plane shown by a double dot and dashed line in FIG. 7, and is two-divided. The cut plane shown by the double dot and dashed line passes at the intersecting section of the magnetic film 17 of the thin piece 18 and the magnetic film 17 of the thin piece 20 along the different direction from the bisecting plane 21. On the cut plane, the plural head parts are formed with larger pitch than the first embodiment.

The other respects are the same as the first embodiment.

According to the fourth embodiment, various advantages as the same as the first embodiment can be obtained.

Next, the fifth embodiment of the present invention is explained. In the fifth embodiment, a probe used for a probe microscope and the method for producing the probe are explained.

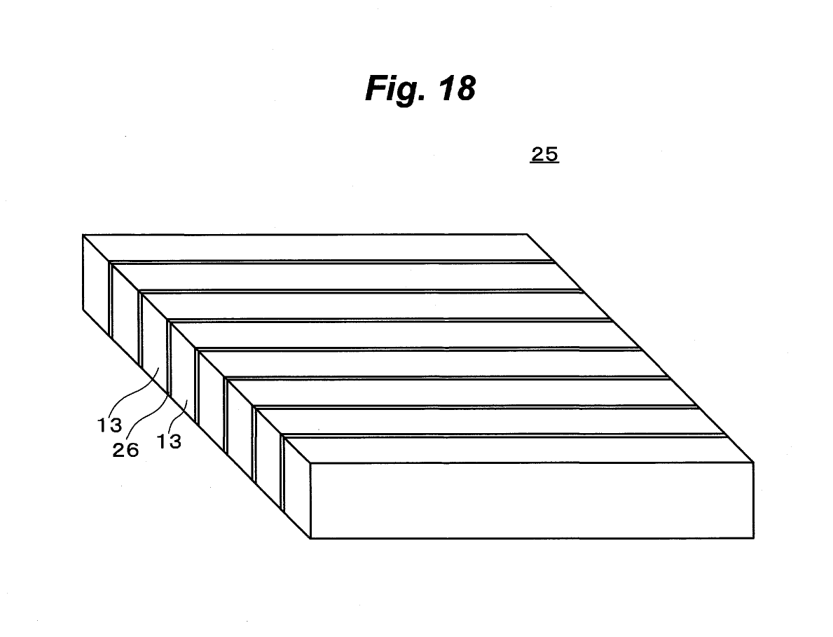

In the fifth embodiment, instead of the magnetic film 17 in the first embodiment, a nonmagnetic metal film is used. More specifically, in the vacuum evaporator shown in FIG. 1, instead of forming a magnetic film, a nonmagnetic metal film is formed. And, as the same as the first embodiment, a disc-shaped spiral structure as the same as shown in FIG. 2 is formed, and a part of the spiral structure is cut down as shown in a dot and dashed lined quadrangle (a rectangle or a square) of FIG. 2. A thin piece 25 cut down by the method is shown in FIG. 18. As shown in FIG. 18, in the thin piece 25, a stripe-shaped dielectric layer 13 and metal film 26 are formed each other to in-plane direction alternately and periodically. Here, the thickness of the dielectric layer 13 is, for example, 0.2 nm or more and 50 μm or less, and the thickness of the metal film 26 is 0.2 nm or more and 100 nm or less, but is not limited to this.

Next, as the same as the first embodiment, on the thin piece 25, another thin piece having just the same structure as the thin piece 25 is stacked through a spacer layer made of a dielectric material such that those dielectric layers 13 and metal films 26 intersect each other at the angle of 90° to form the stacked structure. The thickness of the spacer layer is appropriately selected according to the gap length of the probe part. The spacer layer is the same as the first embodiment.

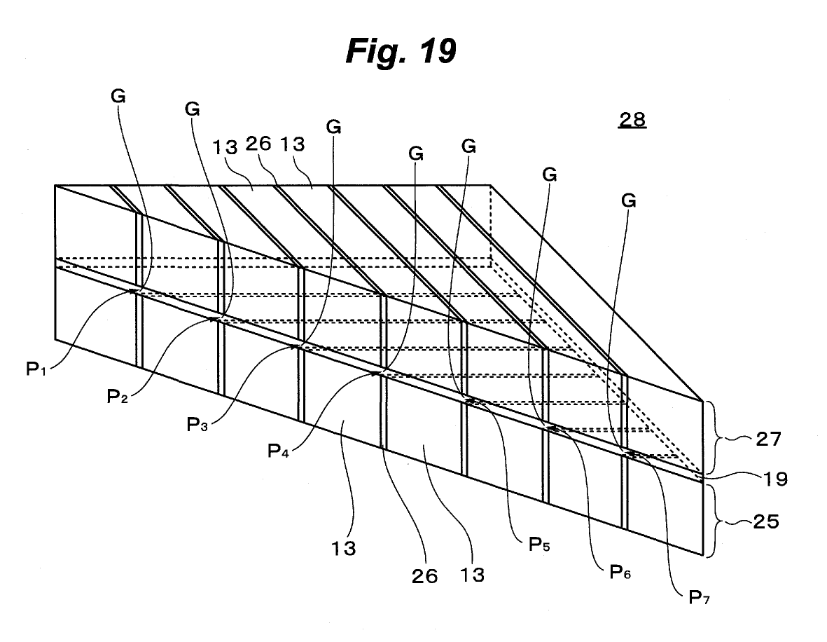

Next, the stacked structure wherein the thin piece 25 and another thin piece having the same structure as the thin piece 25 are stacked is cut down as the same as the first embodiment, and is two-divided. One triangular prism fragment two-divided this way is shown in FIG. 19. In FIG. 19, another thin piece having just the same structure as the thin piece 25 is shown with a reference numeral 27. The triangular prism fragment constructs a probe 28. As shown in FIG. 19, in the probe 28, on the bottom surface made of a cut plane, the plural probe parts (for example, probe parts P₁ to P₇) having a structure wherein the edge of the metal film 26 of the thin piece 25 and the edge of the metal film 26 of the thin piece 27 face with a gap G formed with the spacer layer 19, in the direction of its width are arranged with an equal distance in linear fashion. In each probe part of the probe 28, voltage can be applied between the metal film 26 of the thin piece 25 and the metal film 26 of the thin piece 27 by the outside power supply. In this case, as the probe 28 has a structure that the edge of the metal film 26 of the thin piece 25 and the edge of the metal film 26 of the thin piece 27 face, electric field can be concentrated very high density for a gap G formed by the spacer layer 19, and it is possible to detect easily by each probe part (see a relevant explanation of FIG. 10B of International Publication No. 06/035610).

According to the fifth embodiment, it is possible to obtain easily a multi-type probe 28 wherein the plural probe parts having a structure that the metal film 26 of the thin piece 25 and the metal film 26 of the thin piece 27 face with a gap G having a gap length determined by the thickness of the spacer layer 19 to the direction of its width is arranged in equal distance in linear fashion. The probe 28, by selecting the thickness of the spacer layer 19 to nanometer or sub-nanometer order, a gap length of each probe part can be made very small to nanometer or sub-nanometer order. For this, the probe 28 can keep up fully with the probe of a micro area of a sample surface. Also, as the probe 28 has the plural probe parts, the plural points of a sample surface can be probed at the same time, and the speed of the probe can be improved drastically. Further, as the probe 28 is made of the stacked structure having two thin pieces 25 and 27 stacked, not only the probe is high in mechanical strength, long in lifetime, but also is easy to handle.

Next, a probe according to the sixth embodiment of the present invention is explained.

In the sixth embodiment, instead of the spacer layer 19 used in the fifth embodiment, a micro spherical ball is used. The other respects are the same as the fifth embodiment.

According to the sixth embodiment, various advantages as the same as the fifth embodiment can be obtained.

Next, a probe according to the seventh embodiment of the present invention is explained.

According to the seventh embodiment, the spacer layer 19 used in the fifth embodiment is not used. Alternatively, the upper surface of the metal film 26 exposed on the major surface of the thin pieces 25 and 27 is dug a predetermined depth from the major surface, especially is dug a distance corresponding to ½ of the gap length. And, the thin piece 27 is stacked on the thin piece 25 such that a major surface wherein the upper surface of the metal film 26 of the thin piece 25 is dug a distance corresponding to ½ of the gap length and a major surface wherein the upper surface of the metal film 26 of the thin piece 27 is dug a distance corresponding to ½ of the gap length contact each other, thereby forming the stacked structure.

After this, as the same as the first embodiment, the stacked structure is cut and is two-divided, thereby producing a probe 28.

The other respects are the same as the fifth embodiment.

According to the seventh embodiment, various advantages as the same as the fifth embodiment can be obtained.

Next, a probe according to the eighth embodiment of the present invention is explained.

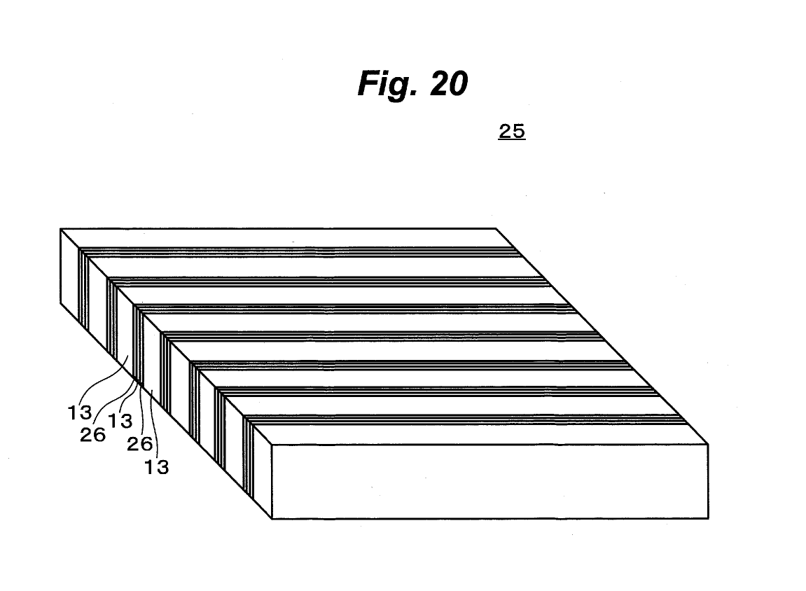

In the eighth embodiment, a thin piece 25 as shown in FIG. 20 is formed. As shown in FIG. 20, in the thin piece 25, the dielectric layer 13 and the metal film 26 are formed alternately, but the thickness of the dielectric layer 13 is changed alternately from t₁ to t₂ (t₂<t₁ or t₂<<t₁). The thickness of the metal film 26 is constant. That is, the dielectric layer 13 and the metal film 26 have a doubly periodic structure. In other words, the thin piece 25 has a structure wherein a pair of metal films 26 provided by sandwiching the dielectric layer 13 with thickness t₂ in equal distance. Also, the thin piece 27 has the same structure as the thin piece 25.

These thin pieces 25 and 27 can be formed as follows, for example. That is, as the same as the first embodiment, in the vacuum evaporator shown in FIG. 1A and FIG. 1B, on a surface of the dielectric layer 13 of a resin base film, etc. sent from the roller 12 is formed a metal film (not illustrated) thinly, by evaporating metal from the evaporation source 14. The thickness of the dielectric layer 13 sent from the roller 12 is to be t₁. Next, a metal film (not illustrated) is formed thinly on the other surface of the dielectric layer 13 by evaporating metal from the other evaporation source not illustrated between the roller 12 and the take-up roller 15. Next, the dielectric layer 13 with thickness of t₂ is formed on the metal film between the roller 12 and the take-up roller 15. To form the dielectric layer 13 with a thickness t₂, an insulator such as, for example, SiO₂, etc. may be vacuum evaporated from the other evaporation source not illustrated, or an insulator is coated by a coater not illustrated. After this, a part of the disc-shaped spiral structure formed by the method is cut as the same as the first embodiment to obtain the thin pieces 25 and 27.

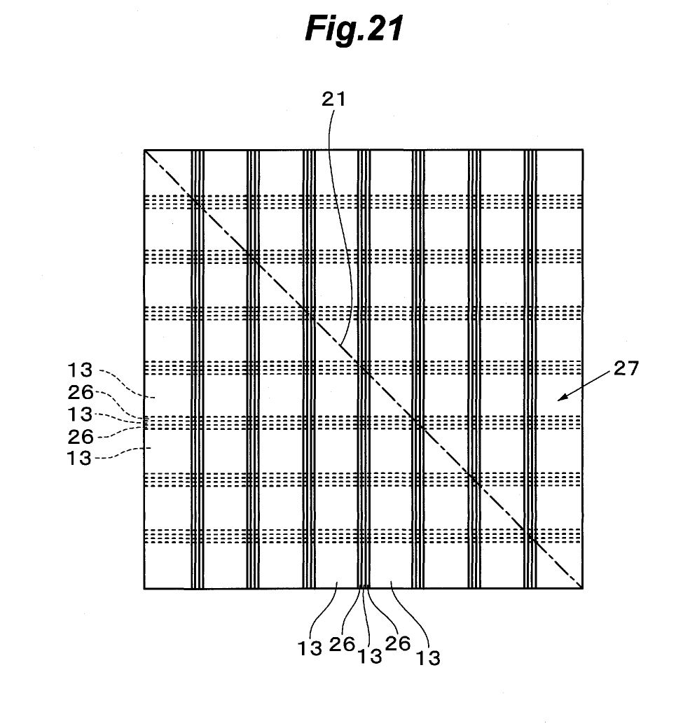

Next, as shown in FIG. 21, as the same as the first embodiment, on the thin piece 25, another thin piece 27 having the same structure as the thin piece 25 is stacked through the spacer layer 19 made of a dielectric material such that those dielectric layers 13 and metal films 26 intersect each other at the angle of 90°, and the edges of the metal films 26 face each other.

After this, the stacked structure is cut along the bisecting plane 21 passing the intersecting section of the dielectric layer 13 and the metal film 26 of the thin pieces 25 and 27 and bisecting the intersection angle of the dielectric layer 13 and the metal film 26, and is two-divided. At this time, the cutting is made to pass both intersecting sections of the metal film 26 closely arranged to the direction parallel to the bisecting plane 21.

The other respects are the same as the first embodiment.

According to the eight embodiment, in addition to various advantages as the same as the fifth embodiment, following advantages can be obtained. That is, according to the eighth embodiment, a multi-type probe wherein a pair of probe parts are closely arranged each other in equal distance on a bottom surface made of a cut plane can be obtained. Also, in this case, for example, a pair of metal films 26 structuring a probe part of the pair of probes closely-arranged each other can be used as the first electrode and the second electrode, and another pair of metal films 26 structuring the other probe part can be used as the third electrode and the fourth electrode, thereby making it possible to realize a proximal 4-electrode type probe.

Next, a probe according to the ninth embodiment of the present invention is explained.

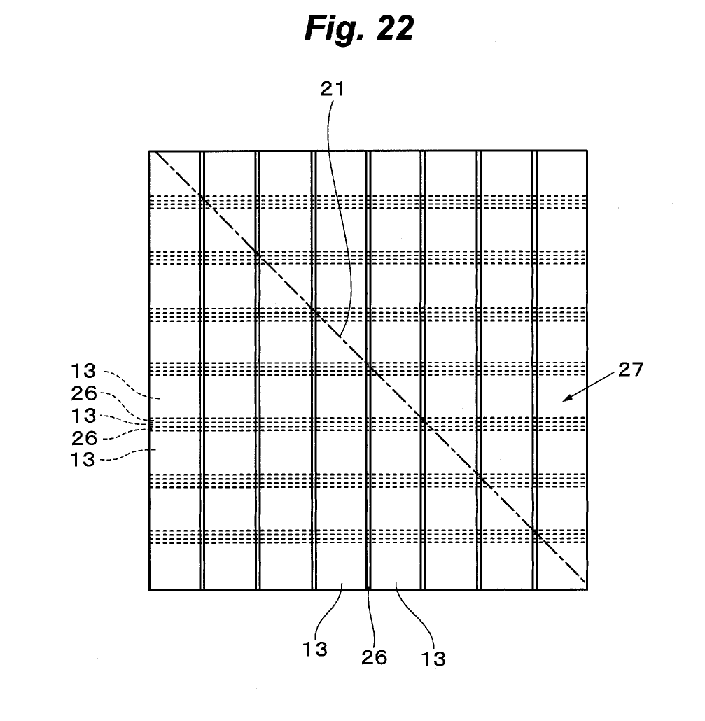

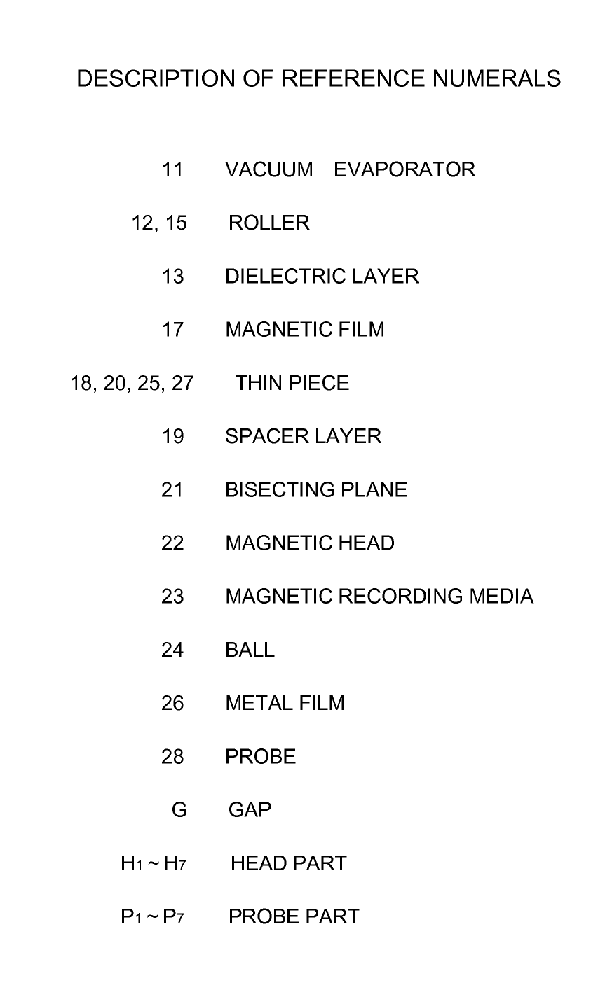

According to the ninth embodiment, the same kind of thin piece as the eighth embodiment is used as the thin piece 25, and the same kind of thin piece as the fifth embodiment is used as the thin piece 27. And, as shown in FIG. 22, as the same as the fifth embodiment, on the thin piece 25, the thin piece 27 is stacked through the spacer layer 19 made of a dielectric material such that the dielectric layer 13 and the metal film 26 intersect each other at the angle of 90°, and the edges of the metal film 26 face to form the stacked structure.

After this, the stacked structure is cut along the bisecting plane 21 bisecting the intersection angle of the dielectric layer 13 and the metal film 26, and is two-divided. At this time, the cutting is made pass to only one intersecting section of the metal film 26 of the thin pieces 25 and 27 arranged closely each other in a direction parallel to the metal film 26 of the thin piece 27.

The other respects are the same as the first embodiment.

According to the ninth embodiment, in addition to various advantages as the same as the fifth embodiment, following advantages can be obtained. That is, according to the ninth embodiment, when a pair of metal films 26 structuring a probe part exposed on the bottom surface made of a cut plane are used as the first electrode and the second electrode, each metal film 26 structuring the intersecting section of the metal film 26 close to the probe part can be used as the third electrode, thereby making it possible to realize a probe with a proximal 3-electrode.

The embodiments and examples of the present invention are precisely explained. However, the present invention is not limited to the embodiments and examples, and a variety of variation based on the technical idea of the present invention is possible.

For example, numerical numbers, materials, shapes, arrangements, structures, etc. presented in the aforementioned embodiments and examples are only examples, and the different numerical numbers, materials, shapes, arrangements, structures, etc. may be used as necessary.

Also, as necessary, more than two embodiments from the first to the ninth embodiments may be combined. For example, in the fifth embodiment, the stacked structure of the thin pieces 25 and 27 may be cut down along the different direction from the bisecting plane 21 as the same as the fourth embodiment. Further, in the first embodiment, the thin pieces 18 and 20 are structured as the same as the thin pieces 25 and 27 of the fourth embodiment, and by cutting the stacked structure of these thin pieces 18 and 20 along the bisecting plane 21, a multi-type magnetic head may be produced as well.

1-15. (canceled)

16. A probe comprising at least two thin pieces that face each other, each piece including conductor layers and dielectric layers laminated therein, wherein at least one pseudo zero-dimensional area is formed by the thin pieces in a two-dimensional plane, and the at least one pseudo zero-dimensional area is exposed on a surface of the thin pieces, thereby making it possible to detect a signal from a direction intersecting the surface.

17. The probe according to claim 16, wherein the at least one pseudo zero-dimensional area is formed by stacking the at least two thin pieces, such that the conductor layers and the dielectric layers of one thin piece intersect the conductor layers and the dielectric layers of the other thin piece, and such that the edges of the conductor layers of one thin piece and the edges of the conductor layers of the other thin piece face each other to define a gap in a two-dimensional plane, and the at least one pseudo zero-dimensional area is exposed on the surface, thereby making it possible to detect a signal from the direction intersecting the surface at a right angle.

18. The probe according to claim 16, wherein the at least two thin pieces include a conductor layer that is sandwiched by dielectric layers, wherein the two thin pieces are stacked such that the conductor layers and the dielectric layers of one thin piece intersect the conductor layers and the dielectric layers of the other thin piece and such that the edges of the conductor layers of one thin piece and the edges of the conductor layers of the other thin piece face each other to define a gap, and the pseudo zero-dimensional area is exposed on a surface made of the two-dimensional plane including the sides of the at least two thin pieces.

19. The probe according to claim 16, wherein the probe has a shape formed by cutting a stacked structure wherein the at least two thin pieces are stacked such that the conductor layers and the dielectric layers of one thin piece intersect the conductor layers and the dielectric layers of the other thin piece, and that the that the edges of the conductor layers of one thin piece and the edges of the conductor layers of the other thin piece face each other to define a gap along a dividing plane passing the intersecting section of the layers or proximate to the intersecting section and dividing the intersecting angle of the conductor layers and the dielectric layers.

20. The probe according to claim 19 wherein the dividing plane is a bisecting plane of the intersection angle of conductor layers and the dielectric layers of one thin piece and the conductor layers and the dielectric layers of the other thin piece.

21. The probe according to claim 17 wherein the at least two thin pieces are stacked such that conductor layers and the dielectric layers of one thin piece intersect the conductor layers and the dielectric layers of the other thin piece at an angle of 90°.

22. The probe according to claim 17 wherein the thickness of each conductor layer is from 0.2 nm to 100 nm, and the thickness of each dielectric layer is from 0.2 nm to 50 μm.

23. A method for producing a probe comprising:
forming a stacked structure by stacking at least two thin pieces, each piece including conductor layers and dielectric layers laminated therein, such that the conductor layers and the dielectric layers of one thin piece intersect the conductor layers and the dielectric layers of the other thin piece and the edges of the conductor layers of one thin piece and the edges of the conductor layers of the other thin piece face each other to define a gap to form at least one pseudo zero-dimensional area; and
cutting the stacked structure along a diving plane passing the intersecting section of the layers or the vicinity of the intersecting section and dividing the intersecting angle of the conductor layers and the dielectric layers of one thin piece and the conductor layers and the dielectric layers of the other thin piece.

24. A probe microscope comprising a probe including at least two thin pieces that face each other, each piece including conductor layers and dielectric layers laminated therein, wherein at least one pseudo zero-dimensional area is formed by the thin pieces in a two-dimensional plane, and the at least one pseudo zero-dimensional area is exposed on a surface of the thin pieces, thereby making it possible to detect a signal from a direction intersecting the surface.

25. The probe microscope according to claim 24, wherein in the probe the at least one pseudo zero-dimensional area is formed by stacking the at least two thin pieces, such that the conductor layers and the dielectric layers of one thin piece intersect the conductor layers and the dielectric layers of the other thin piece, and such that the edges of the conductor layers of one thin piece and the edges of the conductor layers of the other thin piece face each other to define a gap in a two-dimensional plane, and the at least one pseudo zero-dimensional area is exposed on the surface, thereby making it possible to detect a signal from the direction intersecting the surface at a right angle.

26. A magnetic head comprising at least two thin pieces that face each other, each piece including magnetic layers and dielectric layers laminated therein, wherein at least one pseudo zero-dimensional area is formed by the pieces in a two-dimensional plane, and the at least one pseudo zero-dimensional area is exposed on a surface of the elements, thereby making it possible to detect a signal from a direction intersecting the surface.

27. The magnetic head according to claim 26, wherein the at least one pseudo zero-dimensional area is formed by stacking the at least two thin pieces, such that the magnetic layers and the dielectric layers of one thin piece intersect the magnetic layers and the dielectric layers of the other thin piece, and such that the edges of the magnetic layers of one thin piece and the edges of the magnetic layers of the other thin piece face each other to define a gap in a two-dimensional plane, and the at least one pseudo zero-dimensional area is exposed on the surface, thereby making it possible to detect a signal from the direction intersecting the surface at a right angle.

28. A method for producing a magnetic head comprising:
forming a stacked structure by stacking at least two thin pieces, each piece including magnetic layers and dielectric layers laminated therein, such that the magnetic layers and the dielectric layers of one thin piece intersect the magnetic layers and the dielectric layers of the other thin piece and the edges of the magnetic layers of one thin piece and the edges of the magnetic layers of the other thin piece face each other to define a gap to form at least one pseudo zero-dimensional area; and
cutting the stacked structure along a diving plane passing the intersecting section of the layers or the vicinity of the intersecting section and dividing the intersecting angle of the magnetic layers and the dielectric layers of one thin piece and the magnetic layers and the dielectric layers of the other thin piece.

29. A magnetic record and reproduction apparatus comprising a magnetic head including at least two thin pieces that face each other, each piece including magnetic layers and dielectric layers laminated therein, wherein at least one pseudo zero-dimensional area is formed by the pieces in a two-dimensional plane, and the at least one pseudo zero-dimensional area is exposed on a surface of the elements, thereby making it possible to detect a signal from a direction intersecting the surface.

30. The magnetic record and reproduction apparatus according to claim 29, wherein the at least one pseudo zero-dimensional area is formed by stacking the at least two thin pieces, such that the magnetic layers and the dielectric layers of one thin piece intersect the magnetic layers and the dielectric layers of the other thin piece, and such that the edges of the magnetic layers of one thin piece and the edges of the magnetic layers of the other thin piece face each other to define a gap in a two-dimensional plane, and the at least one pseudo zero-dimensional area is exposed on the surface, thereby making it possible to detect a signal from the direction intersecting the surface at a right angle.
